(19) United States
(12) Patent Application Publication
(10) Pub. No.: US 2004/0181757 A1
(43) Pub. Date: Sep. 16, 2004

(54) Convenient accuracy analysis of content analysis engine

(76) Inventors: Deborah A. Brady, King of Prussia, PA (US); William S. Holmes III, Royersford, PA (US)

Correspondence Address: DUANE MORRIS LLP, 100 COLLEGE ROAD WEST, SUITE 100, PRINCETON, NJ, 08540-6604, US

(21) Appl. No.: 10/386,645

(22) Filed: Mar. 12, 2003

(51) Int. Cl. G06F 15/00

(52) U.S. Cl. 715/530

(57) ABSTRACT

A method for evaluating a text content analysis engine includes integrating the software content analysis or evaluation engine with a ground truth module, an accuracy evaluator, and a controller. Under control of the controller of the integrated software, test documents are associated with ground truth, and the test documents are applied to the content analysis engine. The results of the content analysis are compared with the ground truth under control of the controller to produce the desired evaluation.

### FIELD OF THE INVENTION

This invention relates to evaluation of content analysis tools such as may be used for text mining or automatic information extraction from electronic text.

### BACKGROUND OF THE INVENTION

The art of text mining or automatic information extraction from electronic text requires the generation of a “knowledge base” to which a pattern matching module or apparatus applies the text to be evaluated. The knowledge base is the key element in establishing the effectiveness of the information extraction apparatus. The knowledge base includes linguistic rules suited to the language in question. Such rules allow various inferences to be drawn, such as the likelihood that the prefix “Mr.” followed by two capitalized words identifies the name of an individual. Other rules allow the identification of place names. The rules also include various verbs or action words, person names and organization names, which aid in determining relationships of identified individuals to particular organizations, acts, or places.

It will be understood that a knowledge base must be customized to the time in which it is to be used and must also be customized in relation to the types of information which is desired. The time aspect is relevant in that in the words used to identify some subject matter of interest can change over time, as for example in relation to terrorism the term “anarchist” may have a different meaning now than in the early years of the 20th century. A more relevant contemporary term might be “Weathermen” or Al'Qaidah. Also, the names of persons of interest also change with time, in that some malefactors may die and so become less relevant, and new actors enter the stage. Also, a knowledge base directed toward terrorism control may not be particularly useful in mining information relating to national economic activity, for example. Thus, it may be expected that knowledge bases are continuously being changed and adapted, and some new ones are being generated.

The generation of a knowledge base is as much art as science, in that there are almost infinitely large numbers of ways to populate and configure the relationship rules of a knowledge base for extraction of information in relation to particular subjects matter. It becomes important, then, to evaluate the effectiveness of a new or newly changed knowledge base, to verify that it performs its desired functions. It is also desirable to be able to compare various knowledge bases with each other, in order to select those which give the highest likelihood of producing the desired data.

Improved methods are desired for evaluation of knowledge bases.

### SUMMARY OF THE INVENTION

A method according to an aspect of the invention is for evaluating the accuracy of an automated content analysis engine. The method comprises the step of combining with the content analysis engine a ground truth module, an accuracy evaluator, and a controller, to thereby form an integrated software package. The controller is used to control the ground truth module, the content analysis result generator, and the accuracy evaluator, evaluating the automated content analysis engine to produce an accuracy indication. The accuracy indication is at least one of displayed and stored for display. In a preferred embodiment, the step of evaluating the automated content analysis engine includes the steps of selecting test documents, loading the ground truth module with ground truth for the selected test documents, and applying the test documents to the automated content analysis engine to generate results. In a further preferred mode of the method, the results are compared with the ground truth to generate accuracy metrics.

According to another aspect of the invention, a method for evaluating the accuracy of an automated content analysis engine comprises the step of embedding the content analysis engine into a software arrangement together with a ground truth module, an accuracy evaluator, and a controller coupled to the ground truth module, to the accuracy evaluator, and to the content analysis engine, to thereby form an integrated software arrangement. Test documents are applied to the integrated software arrangement under control of the controller. The content analysis engine is applied to the test documents to produce results, and the results and the ground truth are applied to the accuracy evaluator to produce an accuracy indication. The accuracy indication is displayed, stored, or both.

### BRIEF DESCRIPTION OF THE DRAWINGS

FIG. 1 is a simplified representation of how a content evaluation arrangement with a knowledge base is integrated into a software arrangement together with a ground truth module, an accuracy evaluator, and a controller;

FIG. 2 is a simplified logic flow chart or diagram illustrating operation of the software of FIG. 1 to determine the accuracy of a content analysis engine;

FIGS. 3, 4, 5, and 6 are representations of screens which may be presented to a user at various stages of the logic of FIG. 2.

### DESCRIPTION OF THE INVENTION

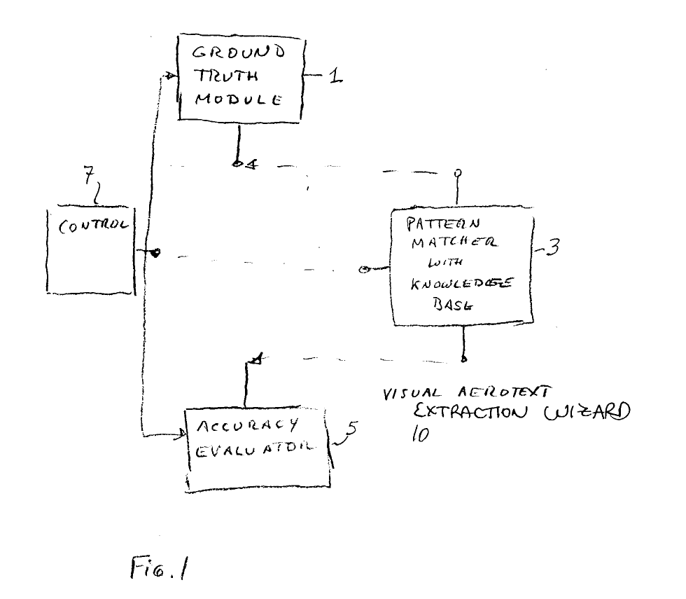

According to an aspect of the invention, the knowledge base to be evaluated is made a part of an integrated software arrangement with an interface controller or “wizard” to aid in performing the various steps of the evaluation. In general, the content analysis engine which is to be evaluated is a software module which can be made a part of a larger software arrangement, as suggested in FIG. 1. The developer or user of the content analysis engine will have available test electronic documents of various complexity for which “ground truth” has previously been evaluated. The ground truth is determined by human evaluation of the test documents, to determine the proper “answers” or “results” which a perfect content evaluation module would produce. These test documents will ordinarily be in electronic form, or are placed in electronic form before use. The ground truth is also in electronic form, or is placed in electronic form before use. In FIG. 1, the ground truth information is illustrated as a block 1.

The content evaluation engine, illustrated in FIG. 1 as a “pattern matcher with knowledge base” block 3, is integrated with a ground truth software module 1 and with an accuracy evaluation module illustrated as a block 5, all associated with a human-interface controller or wizard 7 to form an integrated software system or arrangement designated generally as 10. The ground truth module 1 may simply be a memory in which the various test document files are correlated with their associated ground truth files. A more elaborate ground truth module might include sufficient memory to incorporate the actual test documents themselves, together with the associated ground truth documents. The selection of the test documents and of the associated ground truth information is aided by display presentations of the wizard or controller.

Following the integration of the content evaluator 3 with the ground truth module 1 and the accuracy evaluator 5, and also following selection of the test documents, the wizard 7 of FIG. 1 enables the content analysis engine 3 and passes the text documents thereto or therethrough, so that the content analysis engine 3 produces results for each test document. The wizard or controller 7 then passes the results for each document and the associated ground truth to the accuracy evaluation module 5, for generation of an accuracy indication. The accuracy indication may be displayed at once, stored for later use (together with the identity of the content evaluation engine and the test documents), or both.

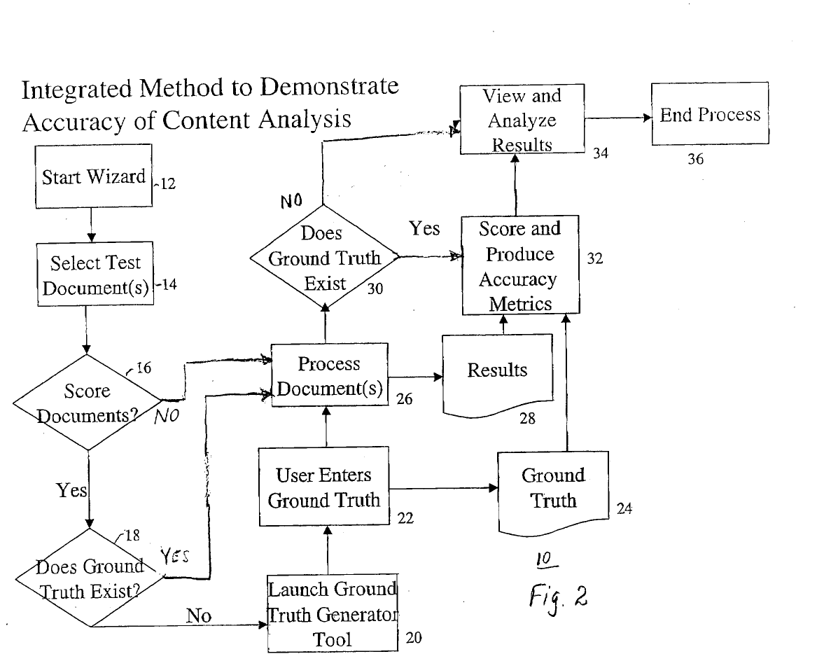

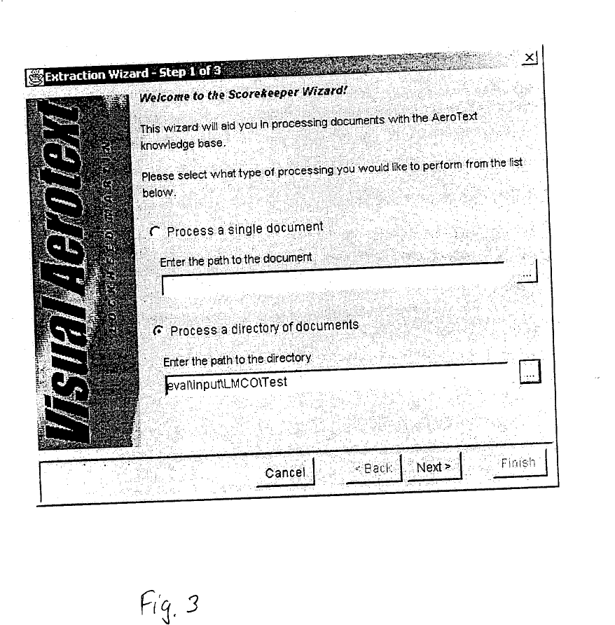

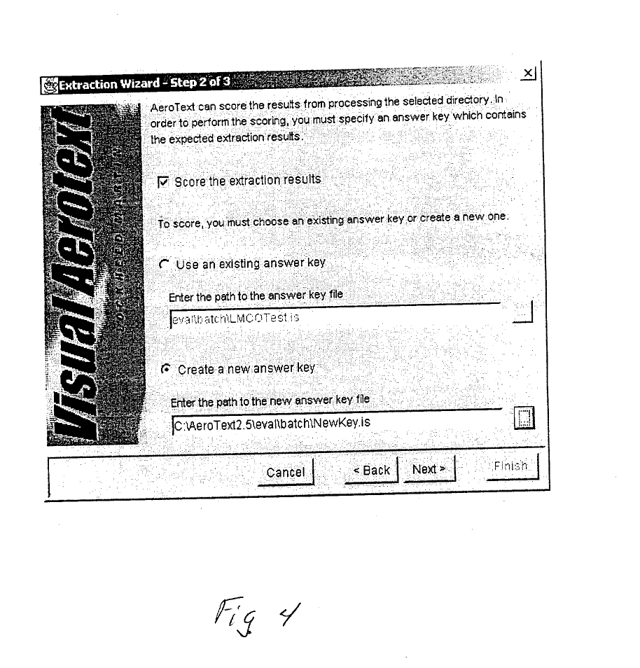

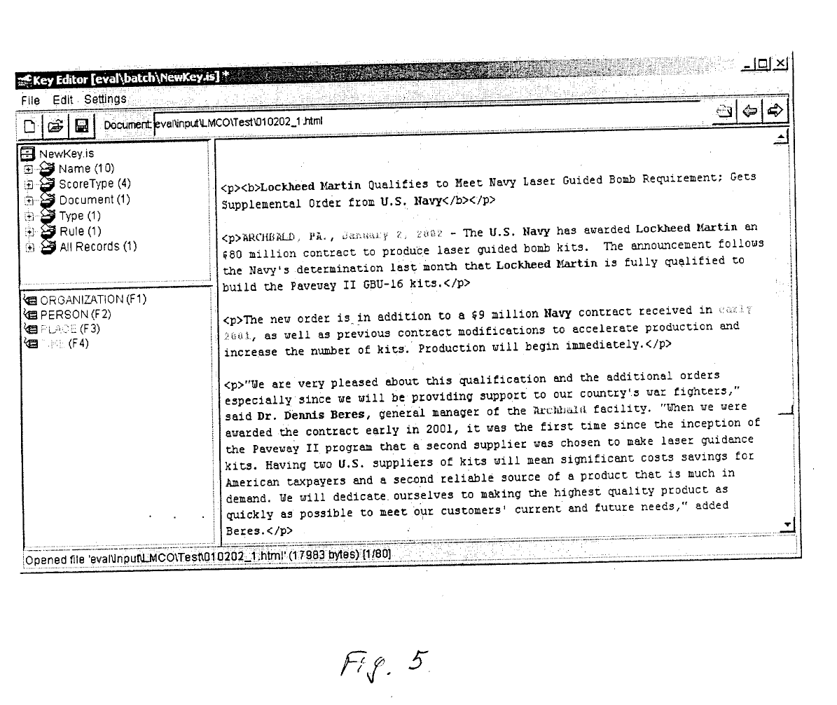

FIG. 2 is a simplified logic flow chart or diagram illustrating the integrated software arrangement 10. The integrated software is named “Visual Aerotext Extraction Wizard.” In FIG. 2, the logic of Visual Aerotext Extraction Wizard, when invoked, begins at a START WIZARD block 12, in which the user is presented with a screen which allows selection of the type of processing desired. FIG. 3 illustrates a representative screen for this step, in which, for example, a single document may be chosen for processing, or a directory may be selected. From block 12 of FIG. 2, the logic flows to a block 14 of FIG. 2, termed “Select Test Document.” Regardless of the selection of a single document or a directory, the logic flows from block 14 to a decision block 16, which determines if documents are to be scored, where “scoring” means the analysis of the accuracy of the results and the producing of metrics. In other words, decision block 16 asks if the user wants to produce accuracy metrics for the Test Documents. If the answer is “no,” the documents are processed directly. If the answer is “yes,” the user is asked if the corresponding ground truth exists. If decision block 16 determines that documents are not to be scored, the logic leaves by way of the NO output, and proceeds to a block 26, representing the processing of the selected documents. If decision block 16 determines that documents are to be scored, the logic leaves by way of the YES path and arrives at a further decision block 18. Decision block 18 determines whether ground truth exists for the documents in question. If ground truth information is available for the selected document or directory, the logic leaves decision block 18 by way of the YES output, and proceeds to block 26, representing the processing of the selected documents. On the other hand, if ground truth does not exist for the selected documents, decision block 18 routes the logic by way of its NO output to a block 20, representing the launching of the ground truth generator tool portion of the software arrangement 10. FIG. 4 illustrates a representative screen which may be presented to the user to allow selection of previously generated ground truth information (answer key) or to allow entry of new ground truth information. The user either selects an existing ground truth or opts to create a new one. If creation of a new answer key is selected, the user is presented with a screen corresponding to that of FIG. 5, in which the text of the test documents is presented, and the matter to be extracted is identified by highlighting a portion of the text and selecting an appropriate type for each answer. The ground truth will then be highlighted in the display window. The entry of the ground truth corresponds to block 22 of FIG. 2. Once the entry of the ground truth is accomplished, it is placed in a Ground Truth memory, illustrated as 24 of FIG. 2.

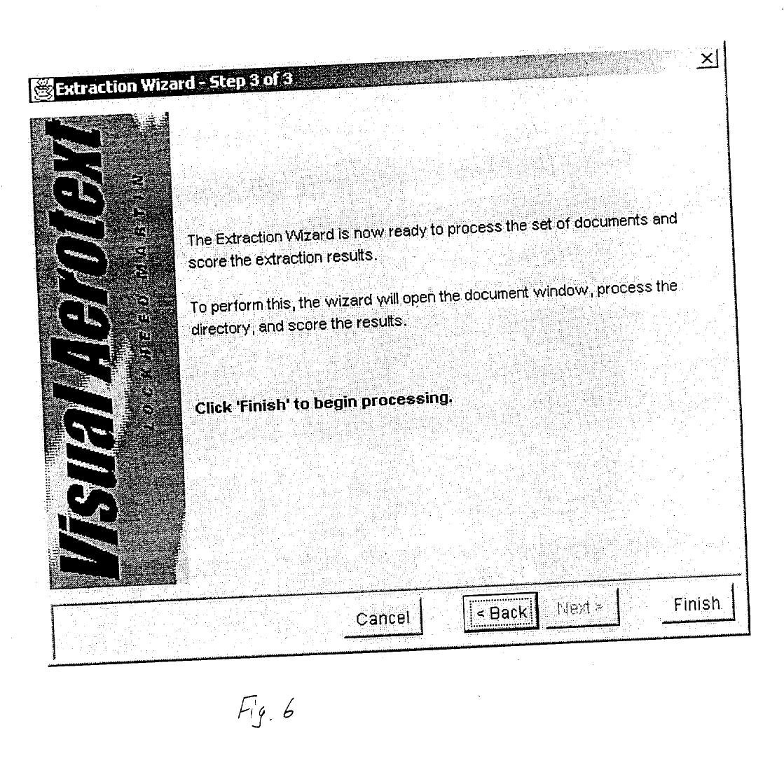

Following the entry of the ground truth in block 22 of FIG. 2, the user is presented with a screen corresponding to that of FIG. 6, requesting authorization to proceed with processing. When authorization is given, the logic flows from block 22 of FIG. 2 to block 26. The documents, if not previously processed, are now evaluated by the content analyzer under test. The “answers” or “results” are stored in memory illustrated as 28 of FIG. 2, and the logic leaves decision block 26 to arrive at a decision block 30. Decision block 30 determines whether ground truth exists for the processed files. If ground truth exists for the processed documents, the logic flows from decision block 30 by way of its YES output to a block 32. Block 32 represents comparison of the results with the ground truth for the processed documents, and production of accuracy metrics.

Following the evaluation of the document(s), the results may be saved for later analysis, or viewed immediately, or both. Block 34 represents the presentation to the user of such results as may be available. In the case in which accuracy metrics have been determined in block 32 by comparison of the results with the ground truth, this information is presented to the user. In the case in which the content analyzer was run in the absence of ground truth, the raw results are presented. From block 34, the logic flows to a process ending illustrated as a block 36.

Thus, a method according to an aspect of the invention is for evaluating the accuracy of an automated content analysis engine or result generator (3). The method comprises the step of combining with the content analysis engine (3) a ground truth module (1), an accuracy evaluator (5), and a controller (7), to thereby form an integrated software package (10). The controller (7) is used to control the ground truth module (1), the content analysis engine (3), and the accuracy evaluator (5), evaluating the automated content analysis engine (3) to produce an accuracy indication. The accuracy indication is at least one of displayed and stored for display. In a preferred embodiment, the step of evaluating the automated content analysis engine (3) includes the steps of selecting test documents (14), loading (22, 24) the ground truth module (1) with ground truth for the selected test documents, and applying (26) the test documents to the automated content analysis engine (3) to generate results. In a further preferred mode of the method, the results are compared (32) with the ground truth to generate accuracy metrics.

According to another aspect of the invention, a method for evaluating the accuracy of an automated content analysis engine (3) comprises the step of embedding the content analysis engine (3) into a software arrangement together with a ground truth module (1), an accuracy evaluator (5), and a controller (7) coupled to the ground truth module (1), to the accuracy evaluator (5), and to the content analysis engine (3), to thereby form an integrated software arrangement (10). Test documents are applied to the integrated software arrangement (10) under control of the controller (7). The content analysis engine (3) is applied to the test documents to produce results, and the results and the ground truth are applied to the accuracy evaluator (5) to produce an accuracy indication. The accuracy indication is displayed, stored, or both.

What is claimed is:

1. A method for evaluating the accuracy of an automated content analysis engine, said method comprising the steps of:
combining with said content analysis engine a ground truth module, an accuracy evaluator, and a controller, to thereby form an integrated software package;
using said controller to control said ground truth module, said content analysis result generator, and said accuracy evaluator, evaluating said automated content analysis engine to produce an accuracy indication; and
at least one of displaying and storing said accuracy indication.

2. A method according to claim 1, wherein said step of evaluating said automated content analysis engine includes the steps of selecting test documents, loading said ground truth module with ground truth for the selected test documents, and applying said test documents to said automated content analysis engine to generate results.

3. A method according to claim 2, further comprising the step of comparing said results with said ground truth to generate accuracy metrics.

4. A method for evaluating the accuracy of an automated content analysis engine, said method comprising the steps of:
embedding said content analysis engine into an integrated software arrangement together with a ground truth module, an accuracy evaluator, and a controller coupled to said ground truth module, to said accuracy evaluator, and to said content analysis engine;
under control of said controller, applying test documents to said integrated software arrangement and applying said content analysis engine to said test documents to produce results, and applying said results and said ground truth to said accuracy evaluator to produce an accuracy indication.

5. A method according to claim 4, further comprising the step of at least one of displaying and storing said accuracy indication.
